(19) United States
(12) Patent Application Publication
(10) Pub. No.: US 2004/0016220 A1
(43) Pub. Date: Jan. 29, 2004

(54) Tumbleweed and light trash collector

(76) Inventor: Edgar George Conley, Las Cruces, NM (US)

Correspondence Address: EDGAR CONLEY, 4504 SANDALWOOD, LAS CRUCES, NM, 88011, US

(21) Appl. No.: 10/206,542

(22) Filed: Jul. 26, 2002

(51) Int. Cl. A01D 43/02

(52) U.S. Cl. 56/344

(57) ABSTRACT

Ubiquitous in arid regions of the Western U.S., tumbleweed (Russian thistle) is a nuisance, especially when the dried plants become detached and thus highly mobile during seasonal winds. Among the many difficulties tumbleweed poses is its tendency to collect along roadway median barriers or fences where it often ensnares light trash and other common highway debris. The volume of such a buildup is often sufficient to form a barrier across the road shoulder and even to encroach on the driving lanes.

The invention gathers tumbleweeds and light trash from the highway right-of-way and transforms it into a higher density material by means of a mulcher/blower. The waste may then be easily transported. The hydraulically powered machine is self-contained, mounts onto the front of a standard utility truck, and is controlled by the cab-seated operator. The machinery dramatically increases the efficiency and safety of the manpower and equipment expended in tumbleweed control.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM COMPACT DISK APPENDIX

Not Applicable

### BACKGROUND OF THE INVENTION

Ubiquitous in arid regions of the Western U.S., tumbleweed (Russian thistle) is a nuisance, especially when the dried plants become detached and thus highly mobile during seasonal winds. Among the many difficulties tumbleweed poses is its tendency to collect along roadway median barriers or fences where it often ensnares light trash and other common highway debris. The volume of such a buildup is often sufficient to form a barrier across the road shoulder and even to encroach on the driving lanes.

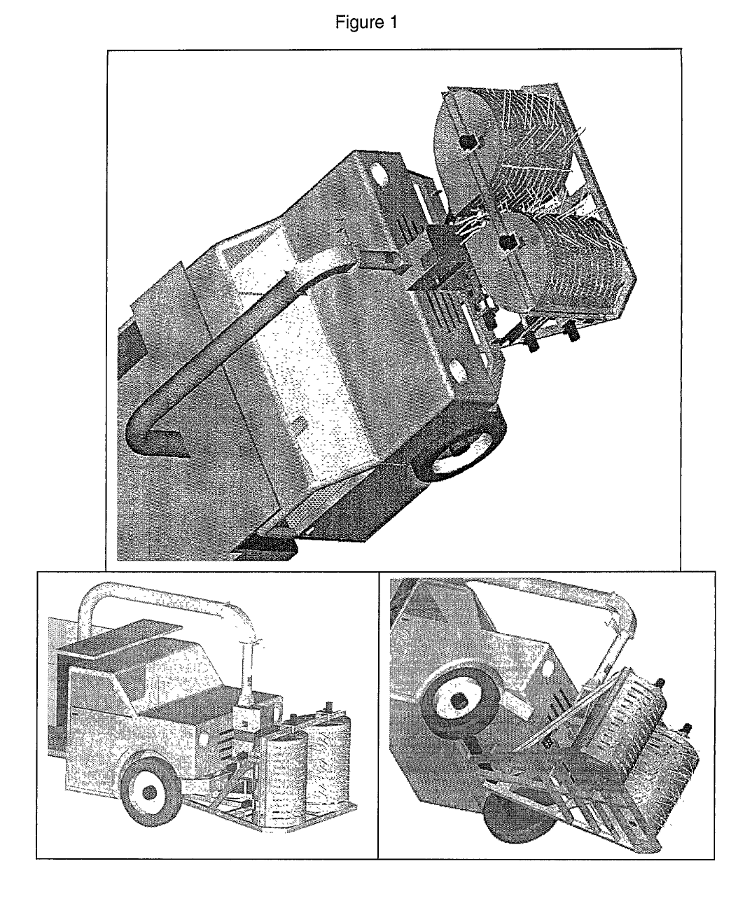

The purpose of the Tumbleweed and Light Trash Collector (TC) is to gather tumbleweeds and light trash (TW) from the highway right-of-way and to transform the waste into a higher density material by means of a mulcher/blower (MB) so that the material can be efficiently transported. The hydraulically powered TC machine is self-contained, mounts onto the front of a standard utility truck, FIG. 1, and is controlled by the cab-seated operator. When it's operating smoothly, the TC dramatically increases the efficiency and safety of the manpower and equipment expended in tumbleweed control. The original TC did not operate reliably, however, hence the object of this utility patent application regards the subsequent improvement to the machinery, which allows it to function smoothly and reliably.

The original machiney was publicly demonstrated early in the year of 1997 and a Provisional Patent, Docket Number 37000-9612, was applied for in Mar. 27, 1997. (A copy of the Provisional Application Cover Sheet is included in the Figures as FIG. 17.) Twelve months later, the provisional status was allowed to expire and full rights to the technology reverted to the present applicant. No action was taken regarding the patent status of the TC or its components until this time.

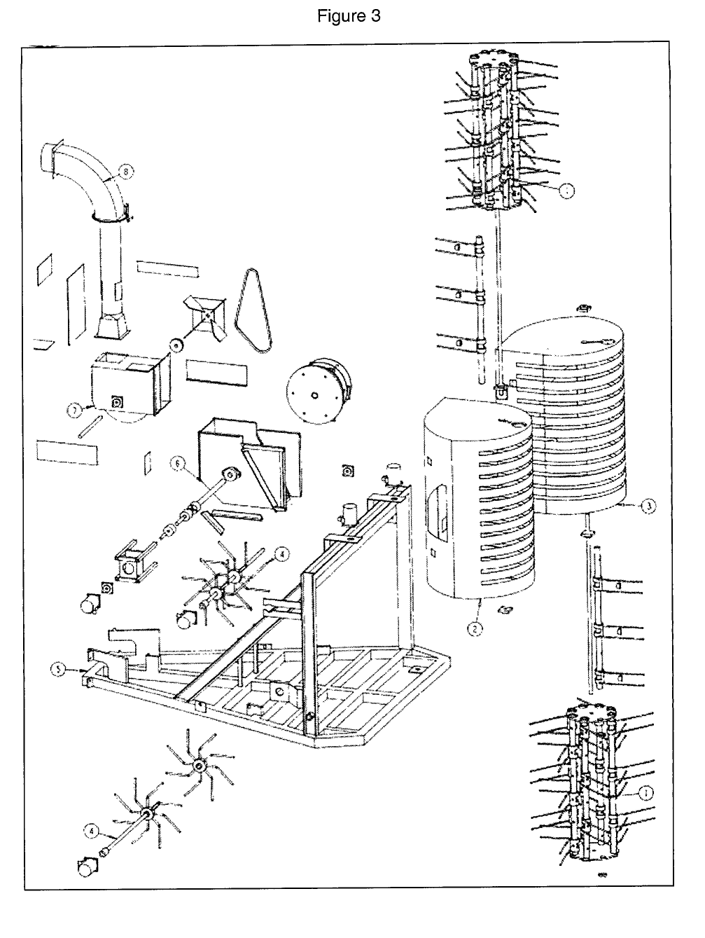

Returning now to the details of the original TC, its low reliability owed to the means by which TW was conveyed or ‘pumped’ through the machinery. Belaboring the metaphor, the TC must function analogously to pumping liquid into a funnel: The generally spherical tumbleweed plant is first ensnared, and then compressed in the horizontal direction by two, vertical axis, counter-rotating, primary reels shown prominently in the exploded view, FIG. 3, and labelled ‘1’. The reels' action, while rotating within the slotted shrouds ‘2’ and ‘3’, produces a TW ‘stream’ that's about one foot wide and four feet high. Individual plant stems resist being deformed, of course, and tend to chafe on the inside of the passageway formed by the shrouds. Owing to the large friction coefficient between tumbleweed's cellulose fibers and steel, the friction force was sufficient to jam the machine. ‘Jam’ means that the tumbleweed simply stopped moving through the machine's innards and instead formed a static clump not far inside the inlet plane. This circumstance occurred whether or not the primary reels continued to rotate.

Further experiments confirmed that tumbleweed resists being pumped. That is, pushing tumbleweed through a tube or duct by wedging additional tumbleweed into the duct from behind does not accomplish the task without imposing extraordinary force. Experiments also revealed that compressed tumbleweed resists being pulled through a given duct since the individual plant stems are brittle and easily break when they're loaded in bending. Compressed tumbleweed must be coaxed along each inch of internal passageway.

In detail, the tumbleweed was urged through the machinery as follows: Two vertical axis, primary reels, labelled ‘1’ in the exploded view of FIG. 3, swept the TW material lying in a region extending across the front of the machine into a converging passageway. The shrouds, labeled ‘2 and ‘3’, formed the passageway. The primary reels' action was similar, but not identical, to that disclosed by Alfs (U.S. Pat. No. 2,188,522).

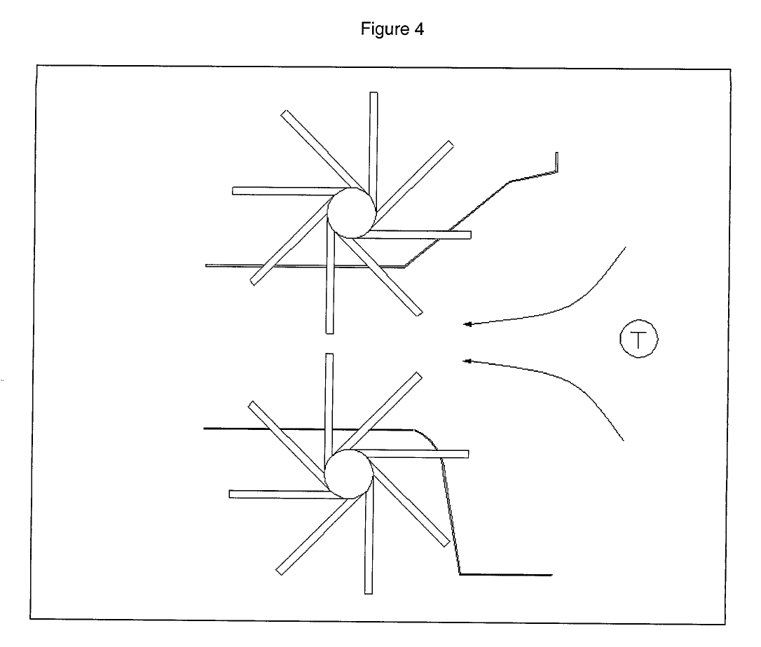

Downstream of the primary reels were four secondary reels which are the relatively small, spoked wheels mounted on two horizontal axes and labelled ‘4’ which are also seen in the exploded view of FIG. 3. Similar in action to their larger, vertical axis counterparts, each spoke rotated through a narrow slot in to, and out of, the throat of the machine. The four secondary reels were arranged, as depicted in the side view, FIG. 4, to compress the TW in the vertical direction and thus ensure a steady flow of waste material through the machinery.

At this point, the TW stream measured very roughly one foot square, roughly the same size as the MB entrance. The MB, identified as ‘6’and ‘7’ respectively in FIG. 3, is a commercially available flywheel-hammermill design. It reduced the cellulose fibers to a maximum length of about 3 inches. The top-mounted blower evacuated the hammermill chamber and directed the fibers up to, and past, a 90-degree elbow. The waste was subsequently blown through an 8-inch diameter flexible tube, secured over the cab of the truck, and into the bed.

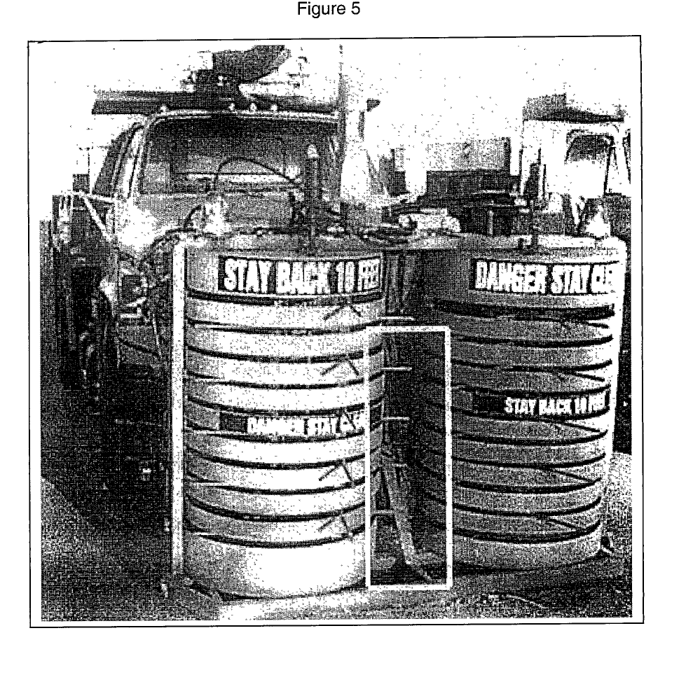

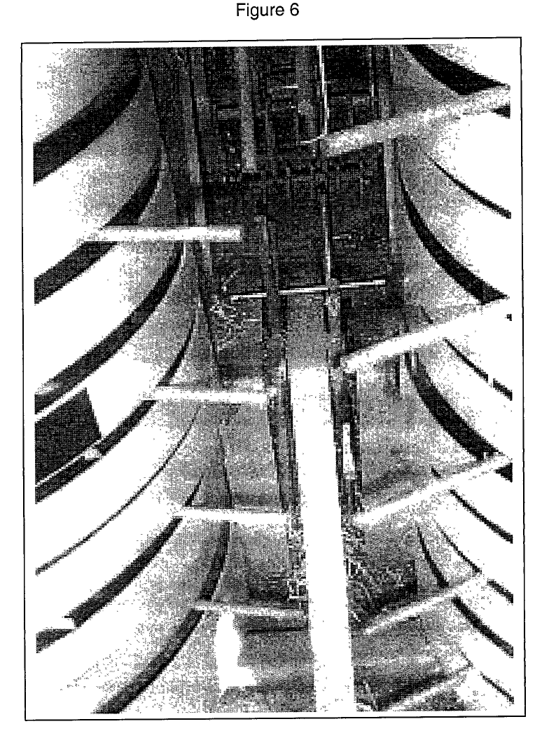

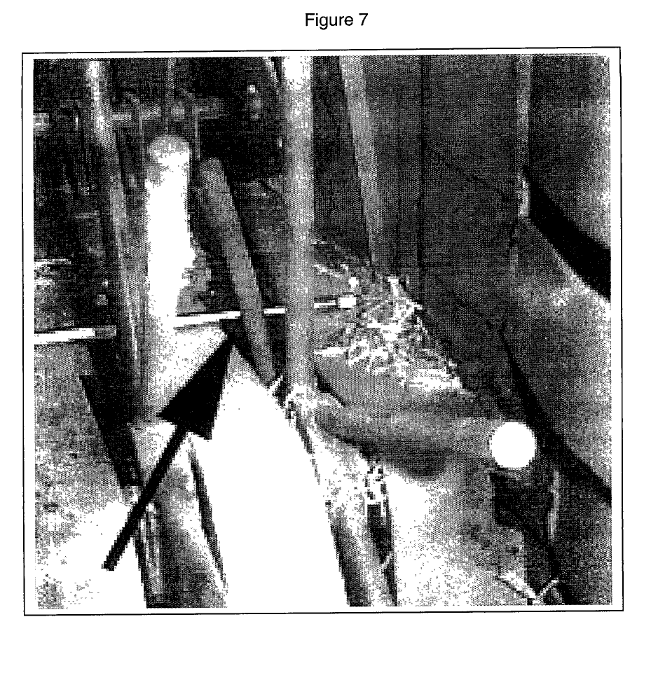

The problem with the machinery became evident with the intermittent jamming of the TW flow in an area outlined in FIG. 5. Any stout stalk of tumbleweed that happened to become oriented as is the bright steel shaft placed crosswise in FIGS. 6 and 7 easily stalled the secondary reels, which prevented them from doing their job.

The original machine demonstrated that the rotating spoke design works well when incorporated into the primary intake stage, but not nearly as well in the secondary stage. In fact, the secondary, smaller sets of rotating spokes caused the machine to jam. Thus there was a need to identify or invent an alternate set of secondary actuators resistant to the tendency to jam.

Twelve patents relating to the present machinery were located among the following classes:

Class 15, subclasses 340.4 and 346

Class 56, subclasses 330, 12.8 and Digest 8

Class 171, subclasses 28, 36, 46 and 58

Class 414, subclass 338

Class 241, subclasses 101.77 and 241

The following U.S. PATENT references were found as a result:

| # | PN | Name | Date | primary intent | intake design |
|---|---|---|---|---|---|
| 1. | 4,974,405 | Littau | 1989 | agri (berrys) | spring fingers (vertical shake) |
| 2. | 5,113,644 | Windemuller | 1991 | agri (berrys) | brush (vertical shake) |
| 3. | 2,188,522 | Alfs | 1940 | brush and trash | chopper (spokes) |
| 4. | 2,777,267 | Thompson | 1957 | agri stalk puller | rotating spokes w/ comb |
| 5. | 3,716,974 | Wehde | 1973 | agri stalk puller | rollers |
| 6. | 4,207,726 | Lippl | 1978 | agri stalk puller | chopper (spokes) |
| 7. | 4,350,207 | Ben-Dor | 1981 | agri stalk puller | wheels & rollers |
| 8. | 4,386,492 | Tilby | 1983 | agri (sugar cane) | rollers |
| 9. | 5,467,828 | Ruozi | 1994 | agri stalk puller | rollers |
| 10. | 3,802,022 | Fleming | 1974 | trash | spokes |
| 11. | 4,232,719 | Payton | 1979 | brush and trash | spokes |
| 12. | 5,848,521 | Kobayashi | 1997 | trash | rake (air) |

The patent search in general revealed that trash/litter collecting and harvesting machinery, including the present one, perform basically three operations—intake, mulching (or any manner of shape change, volume reduction, reorintation, etc.), and depositing of the transformed material into the desired container.

The generic mower/brush cutter designs are not included in this group since their function is to mulch the brush or waste material in place, which is quite the opposite of the TC's purpose.

At this point it is useful to compare the agricultural intent of the disclosures (all except #10, 11 and 12) with the highway use of the TC. Let us assume that each of these was mounted on the front of a sufficiently stout highway vehicle. Then it is a matter to assess the capability of each disclosure to collect TW. This is done as follows.

Of this group, the dedicated ‘berry harvesters’(#1 and 2) are designed to remove the fruit from the stalk while not damaging either one or the other, or either. Obviously these disclosures do not relate to the function of the TC nor are they adaptable as such. Also, the “stalk pullers”(#5, 7, 8 and 9) present an input gap that is far too narrow to ‘ingest’ a mass of TW even if such a mass were initially positioned at the vehicle centerline. In addition, through experiments it was learned that tires or rollers (like those used in #5, 7, 8 and 9) are unable to ensnare and thus convey TW rearward into the mulching stage. Further, despite the somewhat larger gap that would be presented to the TW mass by the patents #3, 4 and 6, the material would still be whisked aside rather than ingested.

In general, the sheer mass of the machinery disclosed in eleven of the twelve patents would preclude its being suspended from the front of a 20,000-pound highway utility vehicle and being transported at highway speeds. A custom vehicle would be required.

To conclude the comparison of the present machine with the twelve disclosures, three in particular, #10, 11, and 12 are cited. First, #10, which is equipped with fingers similar to the present design, clears its spokes as they sweep through a stationary ‘comb’. Many experiments demonstrated that such a comb design does not act to convey TW, but instead the comb simply becomes jammed with it. In contrast to the comb design, the present machine, in picking up tumbleweed, is similar in action to that of a hay baler, which sweeps cut hay from a windrow by means of spokes rotating within a slotted shroud whose axis of symmetry does not coincide with (i.e., is slightly offset from) the spokes' rotational axes.

Disclosure #11 is a funnel design; were it applied to the TC task, it would quickly stall. A funnel or converging channel will readily jam with TW since such a design depends on the TW material that follows to urge the foregoing TW into the machine's innards. Our experiments demonstrated that full-grown TW, which is commonly six feet in diameter, does not transmit in this way. Finally, disclosure #12 presents far too small an intake area to allow it to pick up full size TW. Nor may #12 be adapted to the task, since the air induction system discribed in #12 is not capable of providing sufficient net force to compress full size TW into a converging passageway.

Finally, a careful examination of the referenced devices indicates that four (#3, 4, 6 and 11) may be capable of performing the final two operations on a material like tumbleweed quite adequately. Thus the intake operation, during which the trash and/or vegetation is gathered and then conveyed to the mulcher, sets the present machine apart: None of the twelve referenced disclosures would perform the tumbleweed intake function while remaining free from jamming, and none is sufficiently compact for use on the highway right-of-way.

### BRIEF SUMMARY OF THE INVENTION

As explained above, the primary reels convey the tumbleweed into the region between the shrouds, compressing the waste material in the horizontal direction. In the improved machine, following the primary reels is a second set of actuators, which smoothly compress the TW in the vertical direction and also remain free of jamming.

The secondary actuating fingers are a version of the classic four-bar mechanism. This adaptation reliably compresses the TW stream in the vertical direction while urging the material towards the MB. Owing to the mechanism's unique link design and pin placement, the actuating fingers withdraw in a direction perpendicular to the TW streamline as the fingers approach the mouth of the MB, greatly reducing the chances of a jam. This intake design—the combinating of a primary stage composed of rotating (about a vertical axis) spokes, and a secondary stage composed of four-bar actuated fingers (generally rotating about a horizontal axis)—also renders the machinery sufficiently compact for utility truck mounting and right-of-way use. Thus this intake design, that is, the combination of the primary reels and the secondary actuators, is the object of the present patent application.

### BRIEF DESCRIPTION OF THE SEVERAL VIEWS OF THE DRAWING

1. FIG. 1 depicts three operational views of the original machinery.

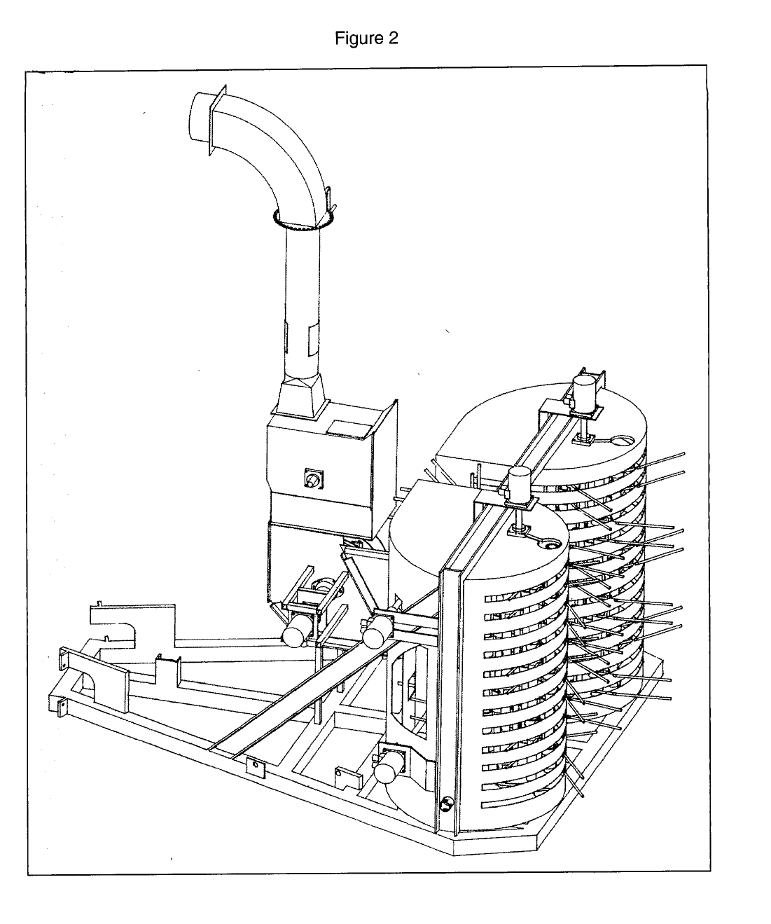

2. FIG. 2 shows some of the original tumbleweed collector details.

3. FIG. 3 shows an exploded view of the original tumbleweed collector.

4. FIG. 4 depicts the hoped-for operation of the original secondary reels.

5. FIG. 5 outlines the problem area of the original machinery.

6. FIG. 6 is a view into the throat of the machine.

7. FIG. 7 illustrates the stalling problem with a arrow.

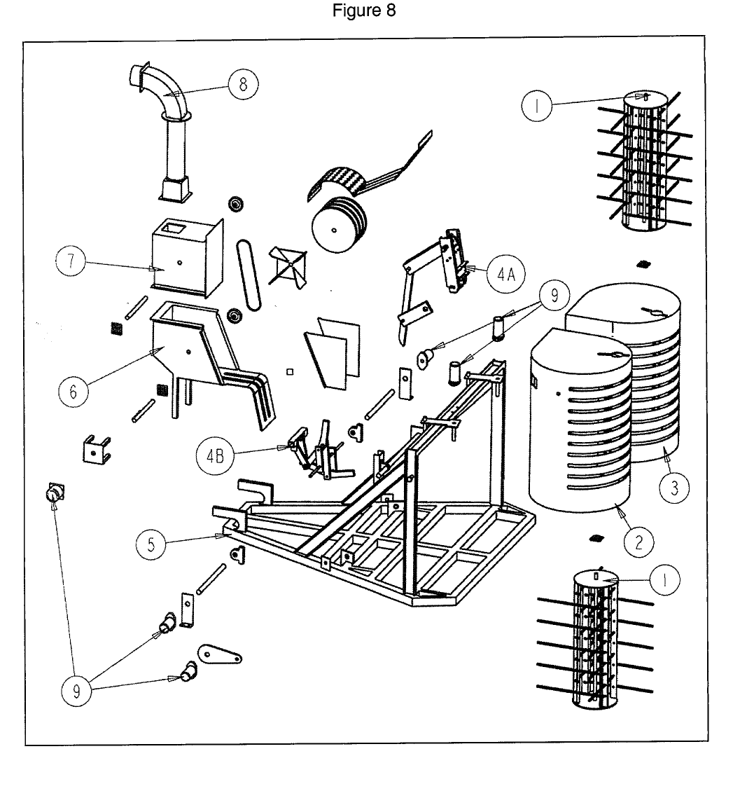

8. FIG. 8 is an exploded view of the revised machine.

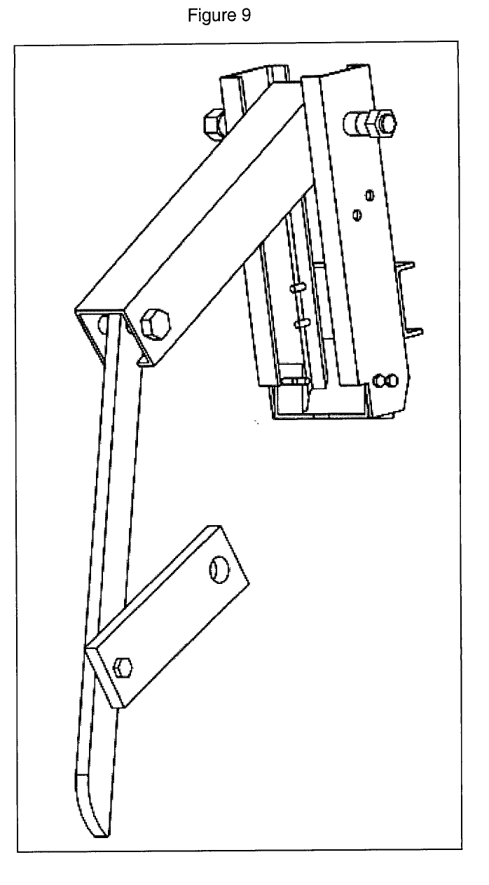

9. FIG. 9 is a detail of the single actuating fingers driven by the upper four-bar mechanism.

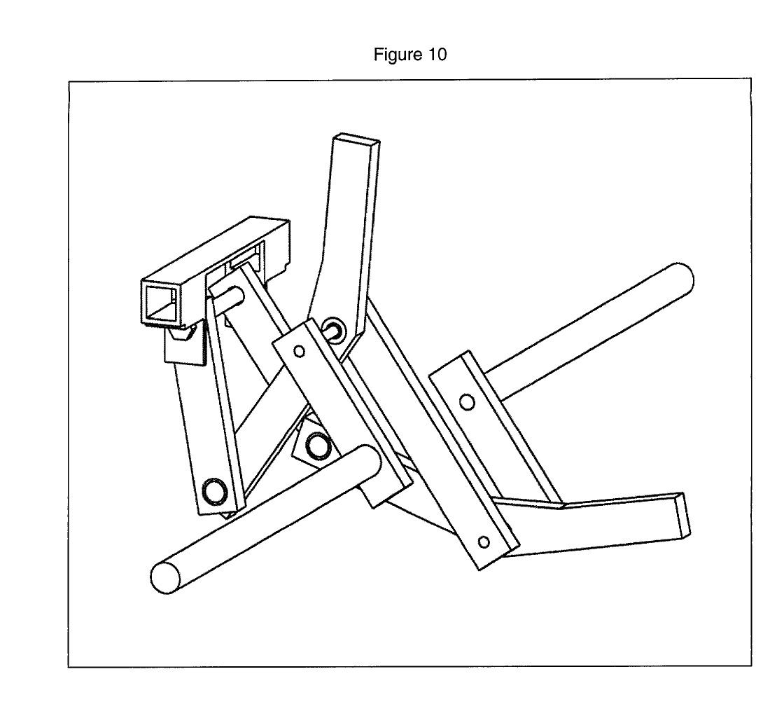

10. FIG. 10 shows the replacement for the lower secondary reels: a four-bar mechanism, which actuates dual fingers.

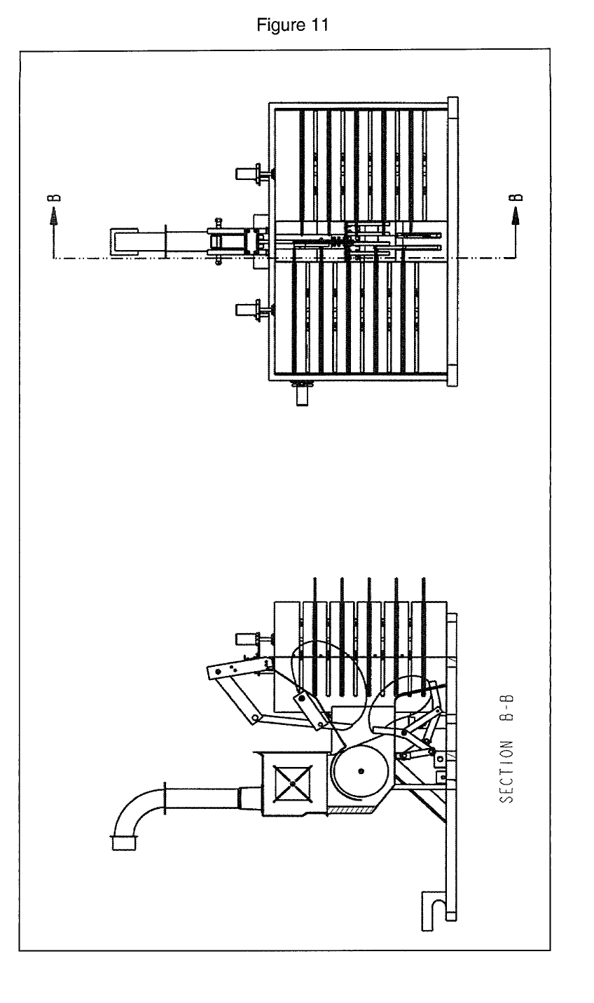

11. FIG. 11 shows the placement of the two secondary four-bar actuators.

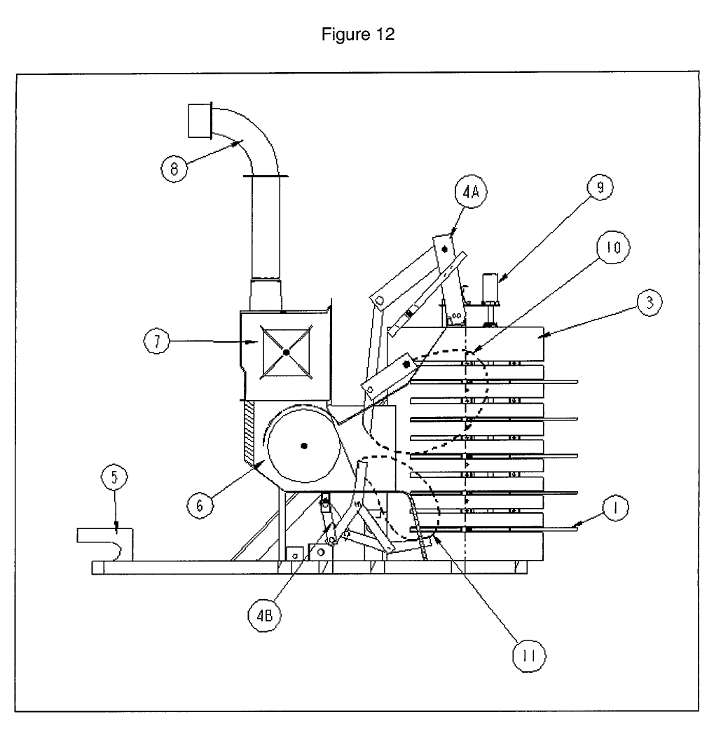

12. FIG. 12 is a detail of the four-bar actuators and their paths through the throat of the machine.

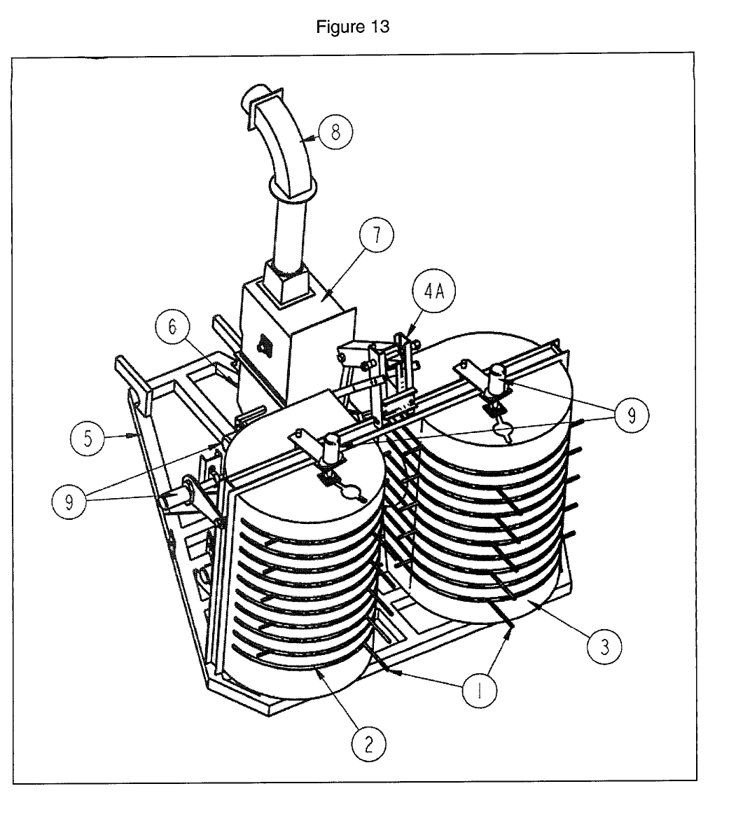

13. FIG. 13 is a top view of the revised machine showing the upper four-bar mechanism.

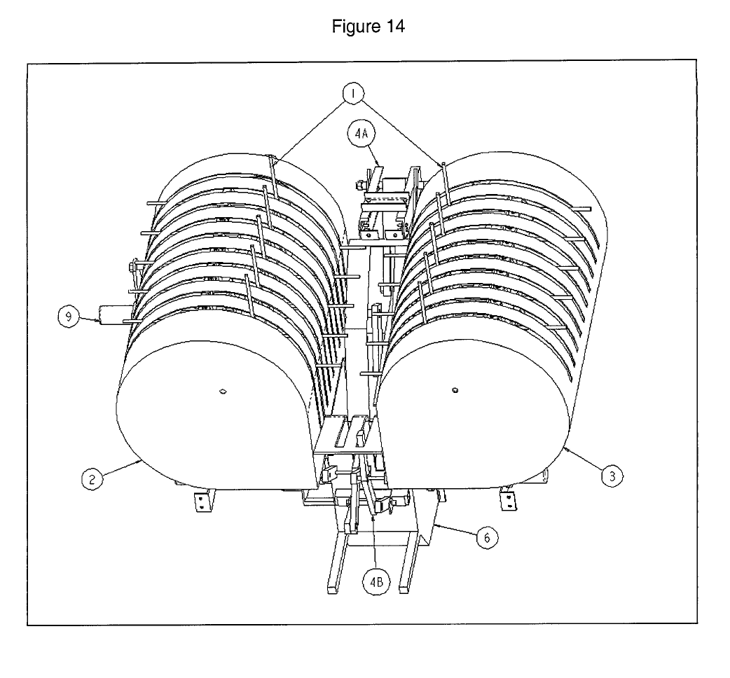

14. FIG. 14 is a bottom view of the revised machine showing the lower four-bar mechanism.

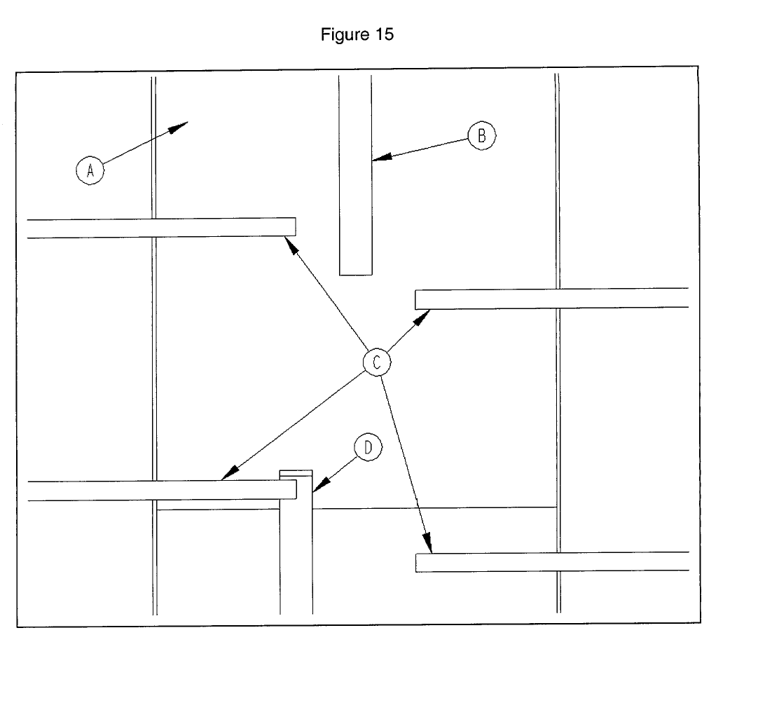

15. FIG. 15 depicts the view along the tumbleweed flow direction toward the MB. Depicted is the maximum penetration of the rotating spokes (extending horizontally from the left and right), and the four-bar actuating fingers (extending vertically from the top and bottom of the duct.

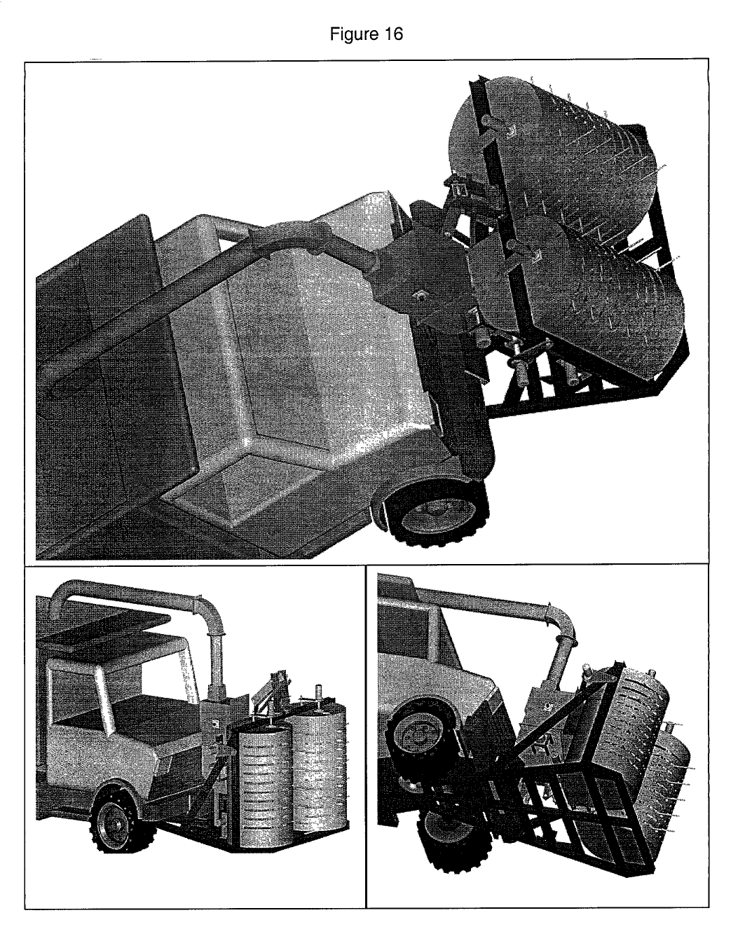

16. FIG. 16 is an operational view of the improved tumbleweed and light trash collector.

17. FIG. 17 is a reproduction of the original provisional patent application (now expired) for the tumbleweed and light trash collector.

### DETAILED DESCRIPTION OF THE INVENTION

The preferred embodiment of the four-bar mechanism is shown in FIGS. 8 through 16. The exploded view of FIG. 8 includes all the components of the improved machine. Overall, the TW is ensnared by the primary reels ‘1’ and guided into the passageway formed by the shrouds ‘2’ and ‘3’. Upper and lower actuators ‘4A’ and ‘4B’ then convey the TW to the mulcher/blower ‘6’ and ‘7’, respectively. The waste material, having been reduced in volume, is then blown through the tube ‘8’ into the truck bed. Rotational power is provided via the hydraulic motors ‘9’. All is mounted on a frame ‘5’ that may be temporarily attached to the front of a utility truck.

FIG. 9 details the upper secondary reel replacement, a four-bar mechanism, labelled as ‘4A’, having a single actuating finger. As the finger sweeps in a vertical plane through the throat of the machiney, the TW material is guided to the MB along a smooth path shown in FIG. 12 labelled as ‘upper actuator path’. The finger then withdraws directly from the flow in a direction parallel to its axis at the left-most point of travel, dramatically decreasing the likelihood of a jam. The top view of the four-bar mechanism, ‘4A’, and its relationship to the overall machinery is seen in FIG. 13.

FIG. 10 depicts the four-bar replacement for the rotating-spoke lower reels. As seen in FIG. 12, as the rear-most links rock forward and aft, the actuating fingers follow a path closely aligned with the direction of the desired tumbleweed flow. At the extreme (left) end of their travel, near the mouth of the MB, the fingers retreat from the flow, greatly reducing the likelihood of said jam. A view of the lower four-bar linkage and its relationship to the overall machinery is seen in FIG. 14.

To further explain the improvement, instead of simply rotating through the tumbleweed flow, as did the original reel, the improved actuating fingers penetrate into the stream alternately. They compress the stream while conveying it towards the MB, and then directly withdraw in a direction generally perpendicular to the streamline and parallel to the actuator axis.

Further, the upper and lower four-bar linkages are located relative to one another so that their actuating fingers nearly overlap at the point of their maximum penetration. Such a configuration is shown in FIG. 15, which depicts the view in the direction of TW streamline. This particular configuration clears TW from the duct fully with each cycle of the actuating fingers.

It is also noted that the mechanical advantage inherent in the four-bar design raises the force on the TW in the direction of the MB at the precise location of the actuating finger that additional force is essential. That is, making full use of the typical constant speed hydraulic power system, the four-bar mechanism urges the TW along its path with ever-higher force at the location that the TW reaches its state of maximum compaction, which occurs near the mouth of the MB.

Finally, the two, relatively short actuating fingers (assembly ‘4B’ in FIG. 12) extending through the lower plane of the duct complement the longer stroke, single actuating finger (assembly ‘4A’ in FIG. 12) extending through the upper plane of the duct. Such an arrangement makes possible a compact four-bar linkage located beneath the duct where road clearance is an obvious constraint. And, owing to the intake configuration, the hydraulic motors (labelled ‘9’ in FIG. 8) that drive the intake reels and fingers need not operate in phase, thus simplifying the power train.

The hydraulic system may be powered by any standard souce, which may be the utility vehicle's PTO and/or an auxiliary motor/pump. Hydraulic motors plumbed in series drive the four primary and secondary intake shafts at roughly equal rotational speeds.

A single pole, double throw, momentary contact switch, located just under the operator's gearshift knob so it may be actuated with an index finger, controls these motors via a standard, electrically powered, directional valve. At the operator's command, the reels rotate in either the intake and reverse rotational directions, depending upon the switch position. The reverse direction is used to clear the occasional jam. A separate on-off hydraulic valve, also located in the vehicle cab, controls the rotation of the MB.

The TC is mounted on a frame, seen as ‘5’ in FIG. 8, that may be hoisted, as is a snowplow, to maintain adequate clearance when the machinery is transported at highway speeds to and from the work site.

What I claim as the invention is:

1. An apparatus for ensnaring, compressing and conveying tumbleweed or any stringy vegetation piled or aggregated next to a fence or any vertical barrier comprising:
a primary intake compression stage that consists of rotating or conveying reels whose sweep extends across the full front of the apparatus in combination with;
a secondary compression stage whose actuators are components of a four-bar mechanism.

2. The apparatus of claim 1 wherein said four-bar mechanisms are highly jam resistant owing to the actuator's path of travel and their orientation relative to the tumbleweed flow streamline; and
which inherently provides increased conveying force (mechanical advantage) on the increasingly-compressed waste material is urged through the machine.

3. The compact and overlapping arrangement of the four-bar actuators, which fully sweeps the throat clear of TW with each cycle of the four-bar actuators.

4. An apparatus that is sufficiently compact so it may be mounted on the front of a standard utility truck that:
is controlled by a cab-seated operator; and
may be powered by the utility vehicle's power take off.
